(19) United States
(12) Patent Application Publication
(10) Pub. No.: US 2016/0283568 A1
(43) Pub. Date: Sep. 29, 2016

(54) SYSTEMS AND METHODS FOR GENERATING MULTI-SEGMENT LONGITUDINAL DATABASE QUERIES

(71) Applicant: DEVEXI, LLC, Fairfax, VA (US)

(72) Inventors: Mitchell PRAVER, Arlington, VA (US); Reuben FIRMIN, Accokeek, MD (US)

(73) Assignee: DEVEXI, LLC, Fairfax, VA (US)

(21) Appl. No.: 15/079,236

(22) Filed: Mar. 24, 2016

Related U.S. Application Data
(60) Provisional application No. 62/137,484, filed on Mar. 24, 2015.

(51) Int. Cl. G06F 17/30

(52) U.S. Cl. CPC G06F 17/30554; G06F 17/30551; G06F 17/30867

(57) ABSTRACT

In some embodiments, a system can instruct a processor to determine a temporal relationship among a set of search parameters for a longitudinal query, and to classify each search parameter from the set of search parameters with a discrete event from a set of events. The system can determine global search parameters for the longitudinal query based on each discrete event from the set of events, and can define a single-segment query for each discrete event from the set of events. The system can also define a multi-segment query based on each single-segment query defined for each discrete event from the set of events, and can query a set of database tables from a longitudinal database based on the multi-segment query to retrieve multi-segment query results. The system can also render the retrieved results in a user interface.

### CROSS-REFERENCE TO RELATED APPLICATION

This application claims priority to and the benefit of U.S. Provisional Application Ser. No. 62/137,484, filed Mar. 24, 2015, and entitled “SYSTEMS AND METHODS FOR GENERATING MULTI-SEGMENT LONGITUDINAL DATABASE QUERIES.” The entire content of the aforementioned application is herein expressly incorporated by reference.

### BACKGROUND

One or more embodiments described herein relate generally to data processing systems, and more particularly, to search query generation based on longitudinal database data, and systems and methods for the same.

Some known information systems routinely receive and process queries for data. Some known information systems can log data from devices connected to a network server, and can use the queries to determine what data to retrieve for users' needs. Some known information systems, however, cannot perform longitudinal analysis of data stored in a database (e.g., cannot process queries which include events related in time). Additionally, without the ability to process longitudinal queries on large data sets across database tables and/or across databases), such systems often cannot draw inferences from, or make predictions based on, the relationship between events and time.

Accordingly, a need exists for systems and methods that can define queries that recognize temporal relationships between events and data in the database, and which can be used to generate complex data studies and/or predictions.

### SUMMARY

In some implementations, a system can include a processor, a longitudinal database operatively coupled to the processor, and a memory operatively coupled to the processor that stores processor-readable instructions executable by the processor to perform a number of steps. For example, the instructions can instruct the processor to determine a temporal relationship among a set of search parameters for a longitudinal query. For example, when the temporal relationship indicates an order, the processor can classify each search parameter from the set of search parameters with a discrete event from a set of events, can determine global search parameters for the longitudinal query based on each discrete event from the set of events, and can define a single-segment query for each discrete event from the set of events. The single-segment query for each discrete event from the set of events can include (1) a subset of search parameters from the set of search parameters that is unique to that discrete event and (2) global search parameters. The processor can also define a multi-segment query based on each single-segment query defined for each discrete event from the set of events, and can query a set of database tables from the longitudinal database based on the multi-segment query to retrieve multi-segment query results. The processor can then render the retrieved multi-segment query results in a user interface.

### BRIEF DESCRIPTION OF THE DRAWINGS

FIG. 1 is a schematic illustration of a client device and a longitudinal data server, according to an embodiment.

FIG. 2 is a schematic illustration of a table graph data structure, according to an embodiment.

FIG. 3 is a logic flow diagram of a method for defining a longitudinal query, according to an embodiment.

FIG. 4A is a logic flow diagram of a method for generating a single-segment longitudinal query, according to an embodiment.

FIG. 4B is a logic flow diagram of a method for generating a multi-segment longitudinal query, according to an embodiment.

FIG. 5 is a logic flow diagram of a method for defining control group/condition studies, according to an embodiment.

FIG. 6 is a schematic illustration of a user interface for defining parameters for a query on a client device, according to an embodiment.

FIG. 7 is a schematic illustration of a user interface for adding parameters for a query on a client device, according to an embodiment.

FIG. 8 is a schematic illustration of a user interface for specifying time parameters for the query, according to another embodiment.

FIG. 9 is a schematic illustration of a user interface for adding events to a query, according to an embodiment.

FIG. 10 is a schematic illustration of an example user interface for query definition, according to an embodiment.

### DETAILED DESCRIPTION

In some embodiments, a query engine can analyze records in one or more databases to determine how they can be organized in time, such that the query engine can develop complex multi-segment Structured Query Language (SQL) queries based on requirements that certain records occur before or after other records (for example, that certain records apply to events or transactions that occurred some number of days before other records). Specifically for health records, this can be used to organize symptoms and/or conditions found in groups of individuals, and can be used to identify longitudinal relationships between the individuals and/or the conditions found within the groups. Longitudinal queries can be queries configured to include time organization, and can be used to compare individuals having a first condition with a control group (or individuals with a second condition), to draw inferences about the nature of the first condition, or similarities and/or differences between the two conditions. The query engine can then perform predictive analysis on a community as a whole to predict prevalence of a condition, predict risks of certain populations exhibiting the condition, predict an order of events that signal having a particular condition, and/or other such measures. The system can also track groups of individuals over multiple user defined points through time.

In some implementations, a system can include a processor, a longitudinal database operatively coupled to the processor, and a memory operatively coupled to the processor that stores processor-readable instructions executable by the processor to perform a number of steps. For example, the instructions can instruct the processor to determine a temporal relationship among a set of search parameters for a longitudinal query. For example, when the temporal relationship indicates an order, the processor can classify each search parameter from the set of search parameters with a discrete event from a set of events, can determine global search parameters for the longitudinal query based on each discrete event from the set of events, and can define a single-segment query for each discrete event from the set of events. The single-segment query for each discrete event from the set of events can include (1) a subset of search parameters from the set of search parameters that is unique to that discrete event and (2) global search parameters. The processor can also define a multi-segment query based on each single-segment query defined for each discrete event from the set of events, and can query a set of database tables from the longitudinal database based on the multi-segment query to retrieve multi-segment query results. The processor can then render the retrieved multi-segment query results in a user interface.

In some implementations, a method can include identifying a set of temporal relationships between each query search parameter from a set of longitudinal query search parameters and the remaining query search parameters from the set of longitudinal query search parameters, and identifying (1) a focus parameter from the set of longitudinal query search parameters and (2) a set of target parameters from the set of longitudinal query search parameters. The method can also include calculating a set of longitudinal database table paths. Each longitudinal database table path from the set of longitudinal database table paths can be a path from a longitudinal database table node associated with the focus parameter to a different longitudinal database table node from a set of longitudinal database table nodes associated with the set of target parameters. The method can further include generating a set of longitudinal query segments based on each longitudinal database table path from the set of longitudinal database table paths. The method can further include combining the set of longitudinal query segments to generate a multi-segment longitudinal query, querying a set of longitudinal database tables based on the multi-segment longitudinal query, and rendering multi-segment longitudinal query results in a user interface.

In some implementations, a processor-readable non-transitory medium can store code representing instructions to be executed by a processor. The code can include code to cause the processor to determine a first subset of search parameters from a set of search parameters, to determine a second sub set of search parameters from the set of search parameters, and to determine a third subset of search parameters from the set of search parameters. The first subset of search parameters can be related to a condition, the second subset of search parameters can be related to one of the condition or a control group of individuals, and the third subset of search parameters can include search parameters common to the first subset of search parameters and the second subset of search parameters. The code can also include code to cause the processor to generate a first longitudinal query based on (1) the first subset of search parameters, and (2) the third subset of search parameters, and to generate a second longitudinal query based on (1) the second subset of search parameters, and (2) the third subset of search parameters. The code can also include code to cause the processor to retrieve first longitudinal query results from a set of longitudinal database tables, based on the first longitudinal query, and to store the first longitudinal query results in a condition longitudinal database table. The code can also include code to cause the processor to retrieve second longitudinal query results from the set of longitudinal database tables, based on the second longitudinal query, and to store the second longitudinal query results in a potential control group longitudinal database table. The code can also include code to cause the processor to compare statistical data generated based on data in the condition longitudinal database table with statistical data generated based on data in the potential control group longitudinal database table to predict information elating to the condition.

In some implementations, a client can define a query for information, which can include events ordered in time. The query engine can define a multi-segment SQL query to obtain the requested information. The query engine can identify common parameters between the events specified by the client, can identify groups of parameters that may apply to each event (e.g., including similar symptoms and/or lifestyle choices), and can construct a query segment for each event that includes both the common parameters and the groups of parameters for the event. For each segment the query engine can construct a single-segment SQL query, which can be combined with each of the other single-segment SQL queries for the other events, to form a multi-segment SQL query. The query engine can then use the multi-segment query to retrieve the information requested by the client.

As another example of longitudinal querying, a query engine can compare a group of individuals with diabetes, with control groups of people who do not have diabetes, in response to a client query. The query engine can match parameters the client provided (e.g., via client input to the query engine) that are associated with diabetes symptoms, medications, conditions associated with diabetes, lifestyle details, when parameters were obtained and/or developed, and/or other such parameters), with parameters that are associated with the control groups. Parameters that are common between the diabetes group and the control groups, along with parameters specifically associated with the diabetes group, can be combined into a first query, which can be used to retrieve condition data. The diabetes data can be placed in a condition table, which can be used to store information about persons in the diabetes group (e.g., the parameter information). The parameters for the control groups can then be used to produce a second query, the results of which can be stored in a controls table. The system can then use the information in the condition table, as well as time data provided as parameters in the client input, to predict how symptoms, medication use, lifestyle details, and/or other such parameters evolved over time to cause a diabetic condition in those persons in the condition table.

As another example of longitudinal querying, a query engine can analyze uses (e.g., on-label uses and/or other uses) of particular medications, to predict and/or identify new uses for such medications. For example, in some implementations, the query engine can retrieve data relating to a particular medication, symptoms and/or conditions and related symptoms) for which the medication was taken by patients, symptoms that were resolved as a result of taking the medication over time, and/or similar information, using a longitudinal query. The longitudinal query, for example, can be generated using parameters such as medication type, condition, symptoms, patient status over a pre-determined time period, and/or similar parameters. The query engine can compare the retrieved information relating to the medication with data relating to a control group population (e.g., data relating to patients and/or conditions for which the medication was not prescribed, and/or the like). The query engine can then use the comparison to draw parallels between known medication usage, and symptoms and/or conditions in the control group, to predict whether or not a medication can be used for symptoms and/or conditions other than those for which it has historically been prescribed. In this manner, the query engine can identify and/or predict additional uses for medication, based on a comparison between standard uses for the medication and features of a control population.

The query engine can also make predictions about persons whose information is stored in the controls table. As one example relating to another condition, e.g., dementia, the system can determine, if people represented in the condition table tend to have certain health behaviors (e.g., cigarette smoking, alcohol and drug usage, diet, etc), tend to elect particular procedures, tend to take particular medications, tend to be diagnosed with particular conditions, and/or tend to have particular symptoms. People represented in the controls table that also engage in certain health behaviors and also exhibit those symptoms that manifest precursors to the condition), may have a higher likelihood of developing dementia than those that do not exhibit these symptoms.

Additionally, further to the example above, based on the timing of the precursors in the condition table, a prediction of when those represented in the controls table would likely develop dementia can be identified. Additionally, the system can use the possible controls table to draw inferences of why people in the controls table did not become diagnosed with dementia despite having similar parameters as the dementia group (e.g., the system can determine whether some people in the controls table made lifestyle changes before people in the dementia table, and whether this had an effect on a population's dementia diagnosis, and/or whether some people's use of a particular medication made them more likely to develop dementia). The system can then also use the condition table to predict which medications people at risk of dementia might potentially benefit from, and how the timing of medication relates to improvement. The system can also compare the tables to determine the statistical significance of certain parameters in causing dementia (e.g., whether particular lifestyle choices and/or particular symptoms actually correlate with dementia, or are coincidentally present in some persons with dementia).

Such longitudinal queries can be executed across linked/integrated data from multiple databases. This allows a large amount of data to be analyzed and used in the longitudinal queries. This also allows combining, overlaying and/or analyzing data for a particular geographic region (e.g., on a county-by-county basis across a country), socioeconomic group (e.g., to include socioeconomic factors in the analysis), and/or the like. Accordingly, the impact and/or risk of such factors on a particular population (e.g., geographic area, socioeconomic group, etc.) can be analyzed.

The query engine can develop a graph data structure representing tables across multiple databases, and can define queries based on paths from a focus point within a table. For example, if a client requests a query for individuals with diabetes who live in a particular geographic area, the system can identify a people table, a diabetes table, and a geographic location table. Since the client is asking for individuals, the system can use the people table as a focus point/table, and can determine graph paths/links between the people table and the filter tables. More specifically, the system can determine graph paths/links between the people table and the diabetes table, and graph paths/links between the people table and the geographic location table. Such graph paths/links can include intervening tables (e.g., tables included in the path between the focus table and the filter tables). The system can generate single-segment SQL queries for each portion of the graph path between the tables, and can join them together into a multi-segment SQL query (e.g., using inner and/or outer joins) that can use at least some data from each of the tables traversed from the people table to the diabetes table and/or geographic location table to return a list of identifiers corresponding to individuals who meet the client's criteria. In some implementations, the tables can exist on multiple external and/or internal databases, and systems and methods described herein can combine and/or overlay data from the tables (e.g., on a country-by-county basis across a particular country, and/or the like).

The query engine can analyze a database and/or a collection of databases to understand how to position events in time. This can allow the user to specify temporal requirements (e.g., “X 30 days before Y”), and can allow the query engine to translate such requirements into complex multi-segment SQL queries.

The systems and methods described herein also support the definition, modification, and processing of studies, e.g., Case/Control studies. A query engine initiating a Case/Control study can retrieve a group of records corresponding to individuals with a certain set of conditions in common, and compare the characteristics of the records to a second group of records corresponding to control group of individuals with a subset of the specified conditions. This allows inferences to be made about the statistical relevance of the conditions not applicable to the control group. A population can be defined in terms of both the core (Case) group and the comparison (Control) group. The query engine can store results for each group in separate temporary tables, and then can analyze an intersection of the two tables to calculate statistical strength of a prediction.

By also storing the same core data in a graph database, the query engine can also identify communities by clustering records corresponding to individuals based on common attributes. This can allow the query engine to make suggestions to the user about additional attributes they may wish to consider when they are running future studies on similar populations. The record clusters can also provide a powerful foundation for modeling populations and conditions.

The systems and methods described herein also support the definition, modification, and processing of other types of studies, such as Cohort studies. For example, a query engine can retrieve a group of records to a group (cohort), e.g., defined by common demographic variables and/or by similar data. The query engine can identify individuals within the group who have been exposed to, and/or diagnosed with, conditions of interest to a user (e.g., a researcher and/or a similar entity). The query engine can divide individuals within the cohort into sub-groups “exposed, diagnosed” or “exposed, not diagnosed”), which can be used in comparisons with other populations within the system to calculate probabilities regarding cohort conditions (e.g., the probability that a person exposed to a condition will be diagnosed with the condition, and/or the probability that the individual will not be diagnosed, such that the system can determine whether exposure is a statistically-relevant factor for the cohort).

The system and methods described herein can also support the definition, modification and processing of studies other than Case/Control or Cohort studies. For example, a user can flexibly define combinations of parameters to produce a study in a particular, customized structure that they wish to follow.

Because the query engine is capable of facilitating both time awareness and community detection (e.g., a population clustering algorithm made possible by graph database storage), the query engine is able to make predictive inferences based on the change within a community over time. Specifically, the strength of the relationship between attributes that define a community, and the members of the community, can be observed using historical data. From this, the query engine can infer whether these attributes become stronger or weaker indicators over time. Additionally, future community membership can be predicted based on historical data analysis of factors that predict inclusion within a particular community. For example, a community's future growth or recession can be predicted based on historical data analysis. Linear regression techniques can be used to model future trends. Predictive models can be defined and can be used to make predictions about newly-observed individuals added to a data set. Logistic regression is an example method used to analyze the fitness of individuals within identified communities (e.g., a measure of how strongly individuals fit particular predefined models of the data). Custom data can be uploaded and mapped to the core schema, and thus to the models. Models defined from historical data can thus allow for strong predictions over population data.

Likewise, custom models (e.g., models defined in terms of the variables available in the database, which can generate a score per individual in the database, such as but not limited to a “probability of individual being diagnosed with cancer,” a “probability that individual had history of poor diet,” and/or the like) can be uploaded, defined in a data analysis programming language, and run against core data and identified communities. Models with good explanatory and predictive power can thus be shared with, discovered by, and tested by users of the system.

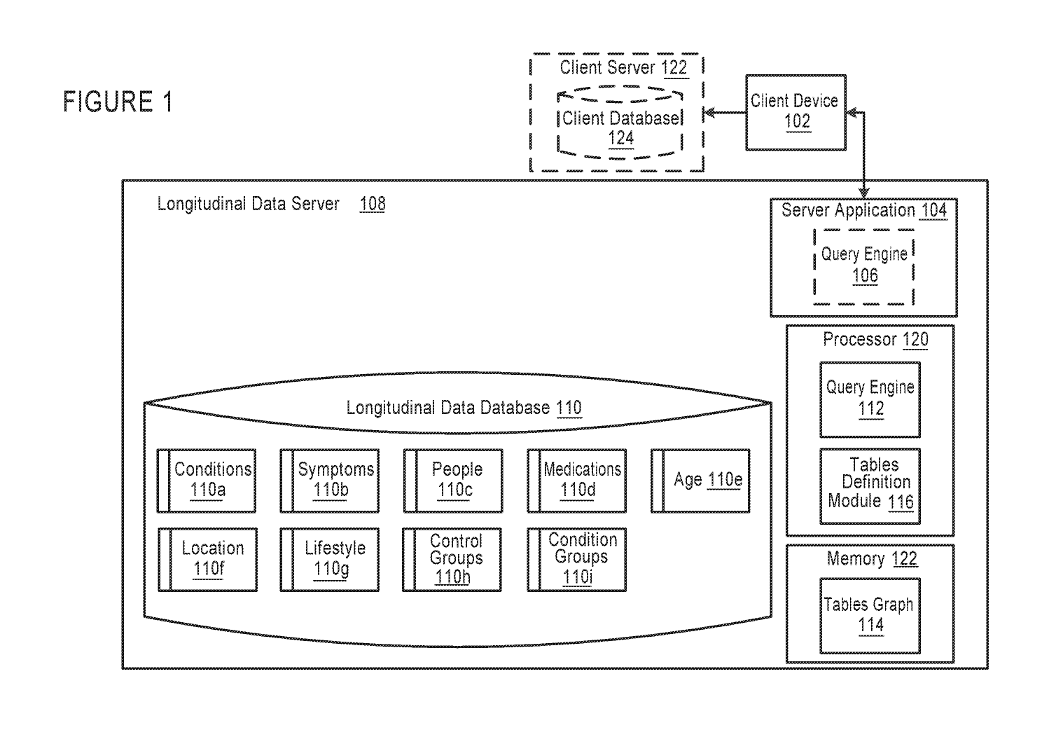

FIG. 1 is a schematic illustration of a client device 102 and a longitudinal data server 108, according to an embodiment. For example, a user can use a client device 102 to form data queries. For example, the user can use the client device 102 to define a query about whether certain medication is effective for diabetes in certain populations, based on data from individuals with diabetes and who have experienced certain symptoms before a certain age. The client device 102 can be a personal computing device (e.g., a laptop, a desktop computer, a netbook, and/or a similar device), and/or can be a mobile computing device (e.g., a mobile phone, a smartphone, a personal digital assistant, a tablet, and/or a similar device). The client device 102 can connect to a longitudinal data server 108, and e.g., via a network connection (e.g., an Ethernet and/or Wi-Fi internet connection, and/or a similar network connection), via a web browser running a server application 104. The client device 102 can also be connected (e.g., via a similar network connection) to a client server 122 hosting a client database 124. The client server 122 can process data the client device 102 receives from the longitudinal data server 108, and/or can store data from the longitudinal data server 108 in the client database 124. The client device 102 can also allow the user to interact with the server application 104 to input query parameters, view retrieved data, view statistical analyses of data within the longitudinal data server 108, and/or to perform related actions. In some implementations the user may not connect the client device 102 to a client server 122, and may depend upon the longitudinal data server 108 to process and/or store such information.

The client device 102 can include a processor or set of processors operatively coupled to a memory or collection of memory modules. The memory or collection of memory modules can be configured to store instructions and/or code for the processor or set of processors to execute. In some implementations, for example, the instructions and/or code can allow the processor to access the server application 104 (described in further detail below), to retrieve and/or display data for the user on the client device 102. The client device 102 can also include data storage modules for storing query data, user information, and/or similar information. In some implementations such data storage modules can include cloud storage, hard-disk storage, and/or the like. The unique architecture described herein can improve the speed and efficiency of data query and analysis.

The server application 104 can be a web-enabled application (e.g., running on the client device 102 and/or the longitudinal data server 108). When the server application 104 is running on the client device 102, the server application 104 can be a software application installed locally on the client device 102, and can be configured to establish a network connection with the longitudinal data server 108 and/or a client server 122 over an intranet connection, e.g., when the user has provided query parameter input. When the server application 104 is running on the longitudinal data server 108, the client device 102 can access the server application 104, e.g., via a browser user interface configured to display the server application 104 for the user, such that the user can interact with the server application to input query parameters, view retrieved data, view statistical analyses of data within the longitudinal data server 108, and/or perform other related actions.

The server application 104 includes a Population-Builder application programming interface (API) and/or similar software to define populations that a user would like to analyze. Using an intuitive web interface, the user can specify criteria for one or more populations (such as conditions, medications used, location of the population, and/or the like), which can allow the user to retrieve data from the longitudinal data database 110. The web interface can allow users to upload and/or otherwise provide their own data, such that the server application 104 can include the data in a query generated for the user. Each of the tables corresponding to the criteria and/or population data retrieved based on a query, can be provided to the user for processing, e.g., via the user's client server 122, and/or via the web interface displaying graphical representations of the query output (e.g., charts, graphs, and/or like graphical representations). The user can then analyze and summarize the constituents of the population, e.g., via sending instructions from the client device 102 to the client server 122. In another implementation, the longitudinal data server 108 can process and/or analyze the data locally, such that the user can receive analysis results for the data without needing to download and/or process the data using her own computing device(s).

The server application 104 can also display dashboards with graphical visualization and output, and statistical summaries specific to the user's prior queries. For example, a user can define a population to analyze, and the longitudinal data server 108 can define a custom dashboard for the user, which is provided to the server application 104 (e.g., running in a web browser) for display. The server application 104 can, in some implementations, also include a version of a query engine 106 (to be described in more detail below).

The longitudinal data server 108 can be an electronic computing system (e.g., a computing device and/or a set of computing devices, and/or the like) that can collect data (e.g., health and/or medical data), process the data based on user requests, and can generate longitudinal queries based on user input. In some implementations, the longitudinal data server 108 can be a server run internally within a company and/or other research entity, or by an individual, and/or a similar entity, in other implementations, the longitudinal data server 108 can be an external server (e.g., run by an external health and/or medical organization and/or the like), accessible via a public or private network connection. The longitudinal data server 108 can include a processor 120 or set of processors operatively coupled to a memory 122 or collection of memory modules. The processor 120 or set of processors can include a query engine 112 used to process query parameters and/or to generate queries for a user, and a tables definition module 116 used to define condition and/or control group tables for predictive queries (described in more detail below). The memory 122 or collection of memory modules can be configured to store instructions and/or code to cause the processor or set of processors to execute one or more modules, and/or can include a tables graph 114 and/or other data the longitudinal data server 108 may use to generate study results (described in more detail below).

In some implementations, for example, the instructions and/or code can allow the processor to receive health and/or similar data, to generate database queries based on user inputs for constructing a query or a study, to generate collections of events and/or persons to facilitate analysis of the data, and/or to generate predictions on future events and/or parameters, (e.g., based on analysis of the data, and/or the like). The longitudinal data server 108 can also include data storage modules (such as, but not limited to, longitudinal data database 110) for storing the health and/or similar data.

The longitudinal data database 110 can include large quantities of de-identified information (e.g., data that has been anonymized and/or otherwise does not include information identifying a particular patient), including but not limited to medical and dental claims representing millions of individuals, and symptoms, diagnoses, prescribed drugs, procedures and short- and long-term outcomes associated with the individuals. This data can be seamlessly linked to additional layers of data, including data on pre-diagnosis exposures to toxins including environmental impact, socio-economic impact, behavioral impact, and/or the like. The server application 104 can analyze the data in a rapid and highly efficient manner understandable by users with limited knowledge of programming and/or general computing principles, e.g., using the systems and methods described herein.

The data can include conditions data 110a (e.g., which can include records about conditions, related symptoms, medications, and/or other information that can define and/or describe a condition), symptoms data 110b (e.g., which can include records about conditions, medications, lifestyle details, and/or other sources of condition symptoms), people data 110c (e.g., demographic and/or like data about people in a population), medications data 110d (e.g., data about medications, the symptoms and/or conditions for which the medications are typically used, and/or similar information), age data 110e (e.g., ages in relation to symptoms, conditions, and/or other data), location data 110f (e.g., information relating to a geographical location at which individuals have been diagnosed with conditions and/or from which other data has been obtained), lifestyle details data 110g (e.g., lifestyle habits of the population, such as exercise frequency, eating habits, and/or the like), control groups data 110h (e.g., data relating to control groups generated for predictive analysis of the control group, and/or the like), condition groups data 110i (e.g., data relating to condition groups generated for predicting characteristics of a condition and/or related parameters, and/or the like), and/or similar information.

The longitudinal data server 108 can implement and/or host the server application 104, such that the user can specify query parameters and request data from the longitudinal data database 110. For example, the longitudinal data server 108 can receive a signal from the client device 102 to provide server application data to the client device 102 such that the client device 102 can display a server application user interface to the user. The client device 102 can display the server application 104 user interface via a browser window displayed on a display screen on the client device 102. The server application 104 can request login information from the user (e.g., a username and/or password) to grant the user access to the data. In other implementations, the server application 104 can be a software package installed on the client device 102, and can be run by the client device 102 (e.g., in a web browser, as an executable program, and/or the like). The server application 104 running on the client device 102 can request login information from the user. The server application 104 can facilitate communication between the user and the longitudinal data database 110, including requesting data from the longitudinal data database. Alternatively, the server application 104 can communicate with the client server 122, e.g., via an intranet and/or a similar internal network, to obtain data for displaying to the user.

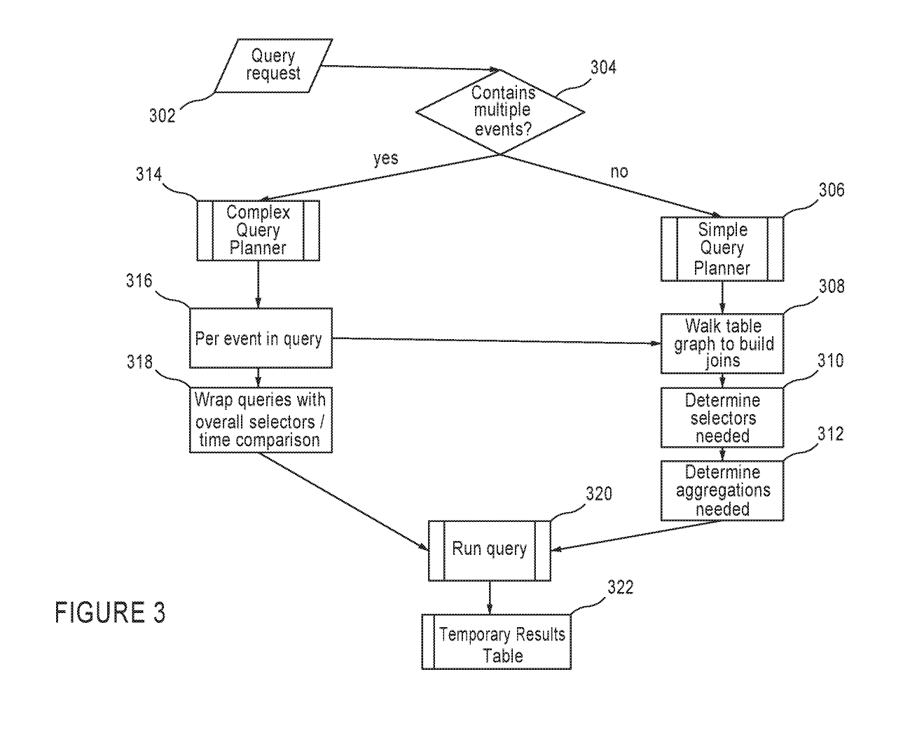

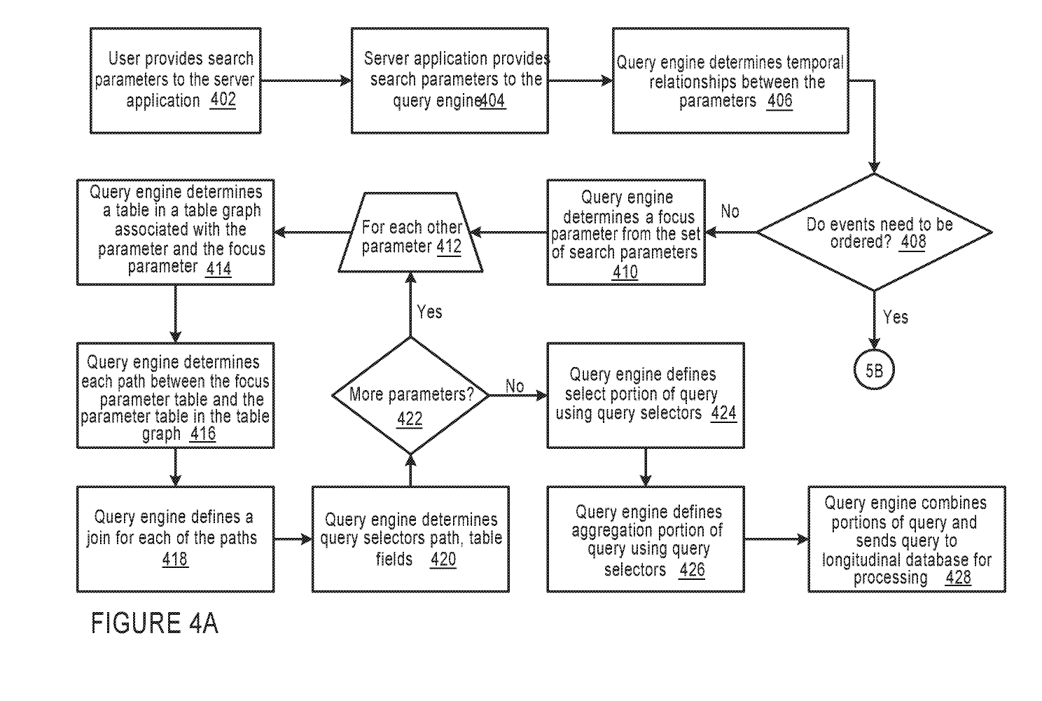

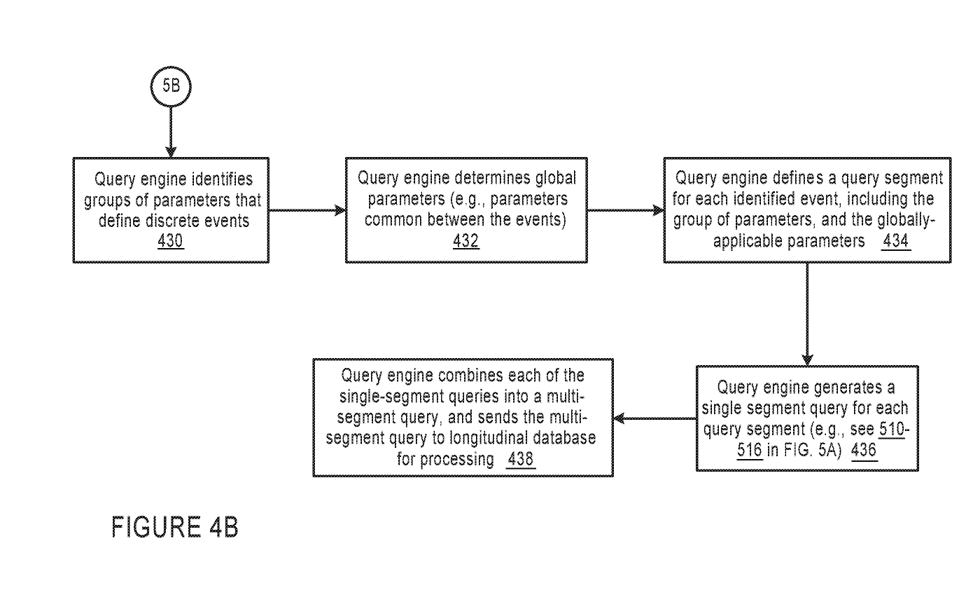

The query engine module 112 described above can be a software module implemented in hardware (e.g., software operating on and/or implemented in the processor 120), a hardware module (e.g., a processor, a circuit, and/or the like), and/or the like. The query engine module 112 can receive query parameters from the user, and can use the parameters to generate longitudinal queries for faster and more efficient querying of relevant data in the longitudinal data database 110, to define case studies of various conditions against control groups defined from the query parameters, and/or to provide data to the user for review (e.g., see FIGS. 3-4B for more details.)

The tables graph 114 described above can be a graph data structure including a representation of each table in the longitudinal data server 108. For example, each table in the tables graph 114 can be represented as a table node in the tables graph 114. The table nodes can be sparsely-connected, can be fully-connected, and/or can have a variable number of connections to other table nodes. The query engine module 112 can traverse the tables graph 114 to determine how to construct a longitudinal query that will incorporate data relevant to the specific events or conditions for which the user is requesting data see FIGS. 4A-B for more details).

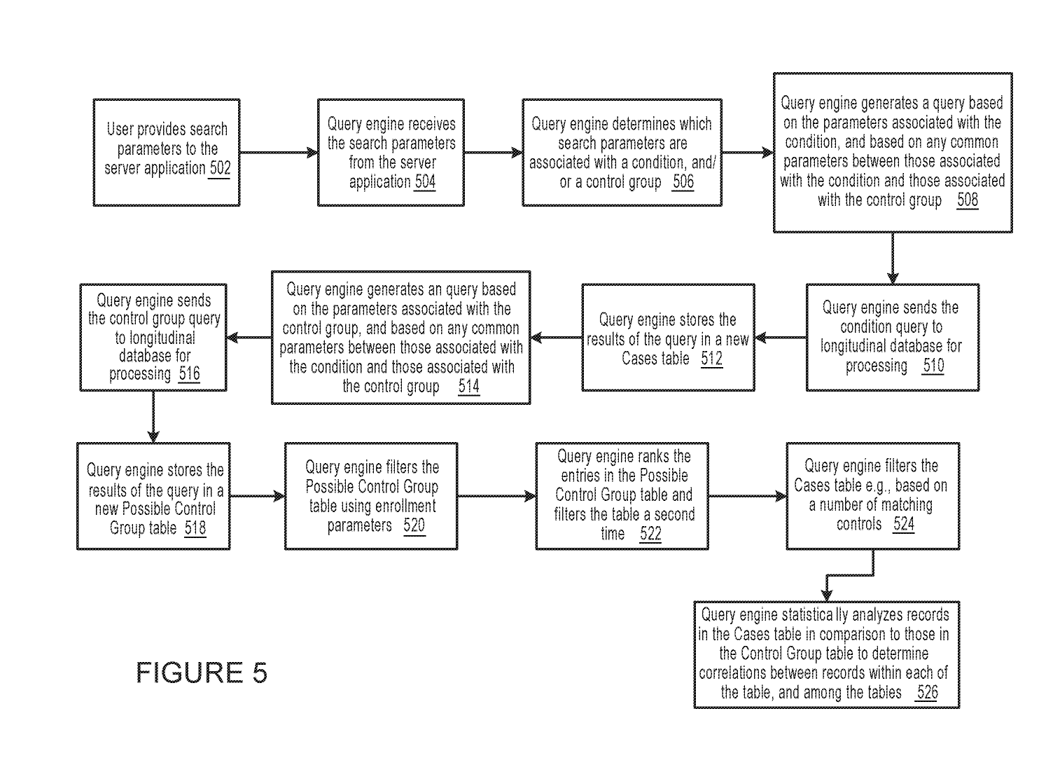

The longitudinal data server 108 can also include a tables definition module 116. The tables definition module 116 can be a software module implemented in hardware (e.g., a processor), a hardware module and/or the like. The tables definition module 116 can facilitate the definition and/or instantiation of control group and/or condition group tables to be used to study a particular condition, and/or analyze the longitudinal data database 110 data as a whole see FIG. 5 for more details).

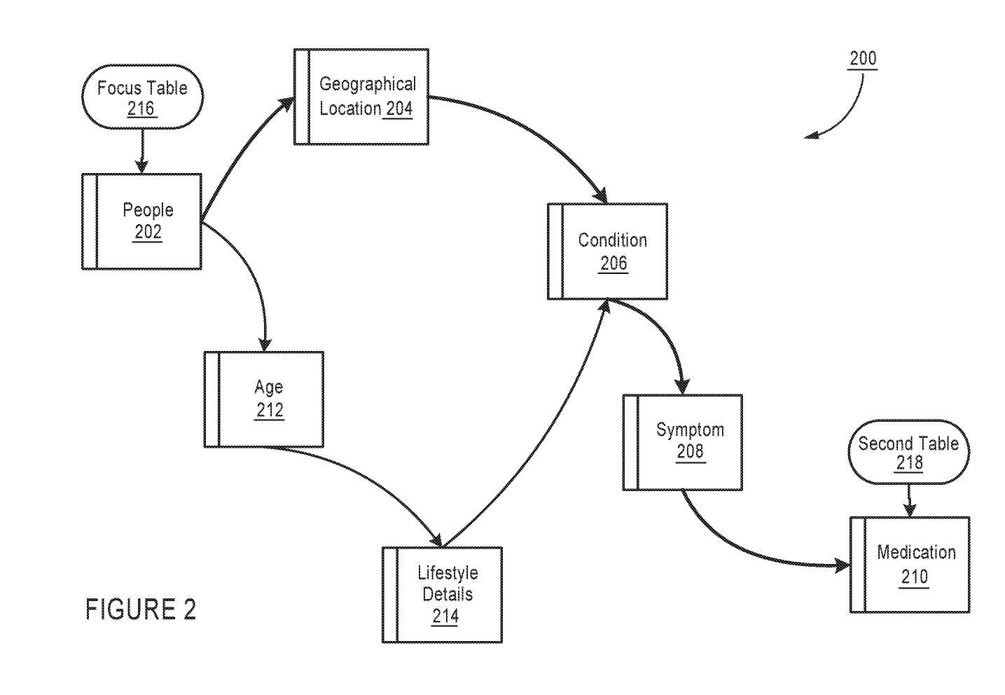

FIG. 2 is a schematic illustration of a table graph 200 (e.g., similar to tables graph 114 of FIG. 1), according to an embodiment. In some implementations, the longitudinal data server 108 at FIG. 1 can include and/or be connected to a number of tables, including but not limited to people table 202, geographical location table 204, condition table 206, symptom table 208, medication table 210, age table 212, and/or lifestyle details table 214. Said tables can exist within the longitudinal data database 110 (e.g., can correspond with tables 110a-110i), and/or on other databases that the longitudinal data server 108 can access (e.g., via a network connection). The table graph 200 can be a graph data structure which connects node representations of these tables together, such that the query engine module 112 within the longitudinal data server 108 can generate queries for data by traversing the graph (e.g., see FIGS. 3-4B for more details). The longitudinal data server 108 can generate the table graph 200, e.g., upon startup, using metadata stored in the longitudinal data server 108 that specifies a topology for the table graph 200. Each table node 202-214 can be connected in the table graph 200 to at least one other table node 202-214, thus forming paths between each of the table nodes. In some implementations, the connections can depend on a relatedness of data in one table that is represented by a table node 202-214 to data in another table that is represented by a table node 202-214, and/or based on similar criteria. For example, in some implementations, the longitudinal data server 108 can determine (e.g., via user input, via previous analysis of data in each table, and/or the like) a relationship between each table node 202-214 represented in the table graph 200. Such a relationship can be based on identifiers, references; and/or any other data stored in each table node 202-214. For example, an identifier or condition in a first table node may correspond with an identifier and/or condition in a second table node. The longitudinal data server 108 can compare relationships to determine how to connect the tables together, such that each table is connected to the other tables with which it has the strongest relationship. The metadata stored in the longitudinal data server 108 can include a representation of these relationships, a representation of the last-known table graph 200, and/or other data that can allow the longitudinal data server 108 to assemble the table graph 200 upon startup.

In some implementations, to generate a query, the longitudinal data server 108 can select a focus table 216 (e.g., a focus event and/or parameter on which to base the search); and can select one or more other tables 218 that the user has specified as parameters for the query as “target” tables and/or parameters). For each other table 218, the longitudinal data server 108 can start at the focus table 216, and determine a path from the focus table 216 to the other table 218. For example a path from the people table 202 to the medication table 210 may include the following:

people table 202—geographical location table 204—condition table 206—symptom table 208—medication table 210.

The longitudinal data server 108 can then construct a query by defining query segments for each portion of the path, and combining the segments into a single query. For example, if identified events were “Exposed to X” and “Diagnosed with Y”, where Y was identified as coming N days after X, a query consisting of at least two segments can be constructed, the first segment relating to and defining X, and the second relating to and defining Y, with an additional clause identifying the time relationship between the two segments. In some implementations the query segments can be SQL segments for a SQL query. The longitudinal data server 108 can repeat this process for multiple target tables, so as to determine multiple paths, and so as to generate multiple queries based on each of the multiple paths. In this manner, the longitudinal data server 108 can generate a multi-segment longitudinal query by generating multiple queries based on multiple paths from the focus table 216, and/or the like. In other implementations, a separate query can be defined for each possible path from the focus table 216 to the other table 218. Thus, the longitudinal data server 108 can also generate a single-segment longitudinal query based on combining queries generated for each possible path from the focus table 216 to the target table 218. The longitudinal data server 108 can use the generated longitudinal query to retrieve longitudinal database data for processing and analysis. For example, a longitudinal query, after being generated, can be used to retrieve data relating to a condition and/or other data, so as to make inferences and/or predictions relating to the information.

FIG. 3 is a logic flow diagram of defining a longitudinal query, according to an embodiment. In some implementations, a user submits, at 302, a request for a query for information. The longitudinal data server 108 can determine, at 304, whether the user's request is asking for information pertaining to multiple events, and/or whether the events are ordered in time (e.g., the user specified one event to occur before another). Events can include, for example, diagnoses, when medication was taken, when symptoms for a condition arose, doctor visits, hospital stays, medical procedures, and/or other such parameters for which time can be a factor. If the user is not requesting a query for multiple events, or if the events are not ordered in time, the query engine module 112 in the longitudinal data server 108 can construct a simple query, at 306, e.g., by building the query through traversing, at 308, the table graph 114. The longitudinal data server 108 can also determine selectors, at 310, (e.g., fields and/or statistics that should be included in the query to narrow the search) and aggregations, at 312 (e.g., fields used to aggregate and/or group data together before running said query) that can be used to construct a query that reaches each of the traversed tables. For example, the longitudinal data server 108 can select two table nodes in the table graph 114 (e.g., a node representing a focus table, and a node representing a target table), determine a best path between the table nodes, and generate a query based on the path (and/or can generate a number of segments each corresponding to portions of the path, and can combine the number of segments into a query for the path). The longitudinal data server 108 can then run the query, at 320, and store the results, at 322, in a temporary results table that can be analyzed to provide the user with the statistical information she requested. (See FIG. 5 for more details.)

If the user is requesting a query for multiple events, and if the events are ordered in time by the user, the query engine module 112 in the longitudinal data server 108 can construct a more complex query 314, e.g., by defining, at 316, a query for each event specified by the user (e.g., in a manner similar to the query defined in steps 308-312), and combining, at 318, the individual queries together into a multi-segment longitudinal query. The individual queries can be combined by using time comparisons to determine how to order the queries and how to apply selectors to the multi-segment longitudinal query as a whole. The longitudinal data server 108 can then run the query, at 320, and store the results, at 322, in a temporary results table that can be analyzed to provide the user with the statistical information she requested. (See FIG. 4B for more details.)

FIG. 4A is a logic flow diagram of generating a single-segment longitudinal query, according to an embodiment (e.g., with reference the components described in FIG. 1). For example, the user can provide, at 402, search parameters to a server application (e.g., server application 104 of FIG. 1). In one example, the parameters can include “children with retrovirus vaccine exposure and intussusception.” The user may also specify whether or not these parameters are temporally-related, and/or whether the parameters should be considered in a particular order. The server application 104 can provide, at 404, the search parameters, and/or information representing temporal relationships between the parameters, to the query engine 112 such that the query engine 112 can define a query to obtain information for the user. The query engine 112 can process the information received from the user to determine, at 406, whether the user specified temporal relationships between the parameters. If the user specified that the event should not be ordered temporally, at 408, the query engine 112 can generate a single-segment query (e.g., a single-segment SQL query).

To generate this single-segment query, the query engine 112 can determine, at 410, a focus parameter from the set of search parameters. In some implementations, the focus parameter can be the first parameter specified by the user, and/or a parameter specifying the types of records the user wishes to receive. For example, if the user wants records of children with various health attributes, the focus parameter may be “children” or “people.” For each other parameter (e.g., “target” parameters) specified by the user, at 412, the query engine 112 can determine, at 414, a table, using the table graph 114, associated with the focus parameter, and a table associated with that other parameter. The query engine 112 can then determine, at 416, a path, and/or all paths, between the focus parameter table, and the other parameter table, using the table graph 114. For example, the query engine 112 can use a searching algorithm, such as but not limited to depth-first and/or breadth-first search, to search through the graph and find a path (e.g., the shortest path, the least costly path, and/or the like) between the focus parameter table and the other parameter table. For each path, the query engine 112 can define, at 418, joins for the query, e.g., to determine how to join the paths together in the query. For example, if parameters requiring the path were filtering parameters, then the query engine 112 can construct inner joins; otherwise, in the case of unfiltering parameters, the query engine 112 can construct left, right, or full outer joins. A parameter can be a filtering parameter when individuals identified by the query match the conditions specified by the parameter. In other words, filtering parameters can identify overall requirements of inclusion within a group of individuals being analyzed. A parameter can be an unfiltering parameter when individuals identified by the query may not match the conditions specified by the parameter, and when the user wishes to collect statistics about those in the group who do match those conditions. In other words, unfiltering parameters can identify subgroups within the group being analyzed, particularly subgroups which may not be related to the filtering parameters. For example; when defining a Cohort Study structure, which may include a wider group of individuals comprising subgroups of those who match certain subsets of conditions, and otherwise individuals who are generally related only by demographics, unfiltered parameters can be used to specify the subsets.

The query engine 112 can then determine, at 420, query selectors for the paths, as well as table fields corresponding to the selectors. If there are more parameters for which to determine paths, at 422, the query engine 112 can continue to identify paths between parameters within the table graph 114, and can continue to join the paths together.

After paths in the table graph 114 for the parameters have been determined, the query engine 112 can define, at 424, select portions of the single-segment query, using the selectors defined at the time each path was determined and using the paths that have been determined. The query engine 112 can also define, at 426, aggregation portions of the single-segment query, e.g., using the selectors. The query engine 112 can then combine, at 428, the portions of the query to form an executable single-segment query, and can send the query to the longitudinal data database 110 such that the single-segment query can be executed. In some implementations, the query can be sent to a task-scheduling module (not shown) configured to control the number of queries received by the longitudinal data database 110, and to reduce the risk of overloading the longitudinal data database 110.

Referring to FIG. 4B, if the query engine 112 determines that the parameters should be temporally ordered, the query engine 112 can identify and/or classify, at 430, groups of parameters that define discrete events (e.g., groups of parameters that define and/or provide context for a single event, such as a condition, and/or a similar event). In one example, a discreet event can be a retrovirus diagnosis, and parameters that define the event can be symptoms (e.g., fever) that led to the diagnosis. The query engine 112 can determine, at 432, global parameters (e.g., parameters that are common between each of the discrete events; also referred to as global search parameters). The query engine 112 can then define, at 434, a query segment for each discrete event, e.g., based on the group of parameters, and the global parameters. The query engine 112 can use each query segment to generate, at 436, a single-segment query for each defined event (in a manner similar to how single-segment queries are defined in FIG. 4A). When the single-segment queries have been defined, the query engine 112 can join, at 438, each of the single-segment queries together to form a multi-segment query, and can send the resulting multi-segment query to the longitudinal data database 110 for processing. In some implementations, the query can be sent to a task-scheduling module (not shown) configured to control the number of queries received by the longitudinal data database 110, and to reduce the risk of overloading the longitudinal data database 110. The query can then be used to obtain information relating to the parameters that were specified by the user. Such information can be used to predict health information, to infer correlations between parameters, and/or to perform other forms of analysis on the data. Based on the analysis, the longitudinal data server 108 can make predictions about how various parameters affect health conditions and/or other events, can make predictions about how health conditions and/or other features of a population may evolve over time based on particular parameters, and/or the like.

FIG. 5 is a logic flow diagram of defining control group/condition studies, according to an embodiment (e.g., with reference the components described in FIG. 1). In some implementations, a user can specify queries to obtain information about multiple populations, allowing the longitudinal data server 108 to automatically analyze the populations and draw current and predictive conclusions about the populations. For example, a user can provide search parameters, at 502, to the server application 104. The server application 104 can forward these parameters to the query engine 112 which, after receiving, at 504, the search parameters, can determine, at 506 which search conditions apply to a condition, and/or which may apply to a control group. For example, if the user provides “adults over the age of 25 with cough, fever, and aching joints symptoms within the past month and who were exposed to the flu,” the query engine 112 can determine that “cough, fever, and aching joints symptoms” apply to a condition of the population, and therefore should be associated with a condition group, while parameters such as “adults” and “within the past month” can apply both to the control group and to the condition group. In some types of studies, parameters can be defined by the user as being associated with “cases” or “controls,” via the server application 104. In some types of studies, parameters can be defined as either “unfiltering” (identifying subgroups within the cohort) or “filtering” (identifying the overall requirements of inclusion within the cohort). In some implementations, the query engine 112 can use a combination of other data from the user, natural language processing of the query parameters, previous parameter classifications (e.g., how parameters were classified in prior searches and/or studies) and/or data from past queries and/or studies, to predict how parameters should be applied.

The query engine 112 can generate, at 508, a query (e.g., similar to the queries described in FIGS. 4A-B) based on the parameters associated with the condition, and based on the parameters that can be applied to both groups global parameters). The query engine 112 can then send, at 510, the condition query to the longitudinal data database 110 for processing, and can store, at 512, the results of the query in a new Cases table in the longitudinal data database 110, and/or in another database. In some implementations, the query engine 112 can update and/or otherwise modify an existing Cases table, e.g., relating to the particular symptoms the user specified, instead of defining a new table. The query engine 112 can then repeat a similar process for a control group. For example, the query engine 112 can generate, at 514, a query based on the parameters associated with control group, and based on the global parameters, and can send, at 516, the generated control group query to the longitudinal data database for processing. The query engine 112 can store, at 518, the results of the query in a new Possible Control Group table, and/or can modify an existing Possible Control Group table defined using the same parameters used to define the query.

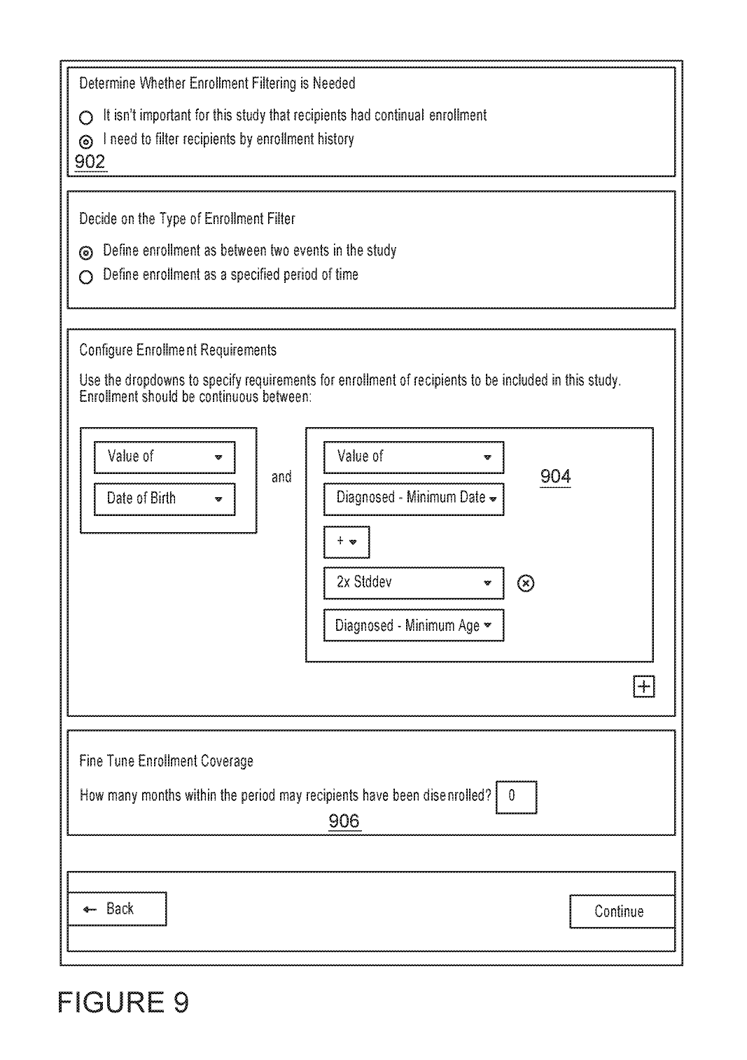

The query engine 112 can then perform a number of steps to remove excess records from the tables. For example, the query engine 112 can filter, at 520, the Possible Control Group table, e.g., using any enrollment parameters specified by the user e.g., see FIG. 9 for more details). Filtering the table can include removing any records that do not meet the enrollment parameters, and/or the like. The query engine 112 can sample, at 522, a number of matching records in the Possible Control Group table, based on, for example, similarities between the records (e.g., similar diagnoses following similar symptoms, and/or the like). In some implementations, the records can be sampled randomly; in other implementations, the records can be selected in part based on user-specified criteria (e.g., criteria for determining how many records to sample, which records to select, and/or the like). The query engine 112 can also filter, at 524, the Cases table, e.g., based on whether there is a matching number of Cases records and Possible Control Group records. Once the tables have been filtered and/or pruned, the query engine 112 can perform, at 526, statistical analytics, and/or can process the data in both tables in various other ways, to compare records in the Cases table to those in the Possible Control Group table. Performing this analysis can generate statistical data that can be compared and/or further analyzed, e.g., to allow the query engine 112 to determine correlations between the tables.

For example the longitudinal data server 108, using the query engine 112, can determine that records in the Cases table share commonalities that suggest that they are related to the condition to which the cases relate, based on comparison to the Possible Control Group records. For example, if many people in the Cases table have a fever, aching joints, and a cough, have been diagnosed with influenza, and have been prescribed Tamiflu™, and if people without these symptoms do not tend to be diagnosed with influenza or prescribed Tamiflu™ the longitudinal data server 108 can determine that there may be a correlation between these symptoms and the condition. The longitudinal data server 108 can use this data, along with time factors, to determine the effectiveness of various medications and/or lifestyle habits in recovering from influenza. The longitudinal data server 108 can also use this data to predict what patients with the symptoms may need in the future. For example, the longitudinal data server 108 can predict that people with cough, fever, and aching joins may have influenza. The longitudinal data server 108 can also use this data to predict an influence of particular medications on said symptoms and/or a condition associated with the symptoms, an influence of a symptom and/or each of the symptoms on the likelihood of being diagnosed with a particular condition; and/or the like.

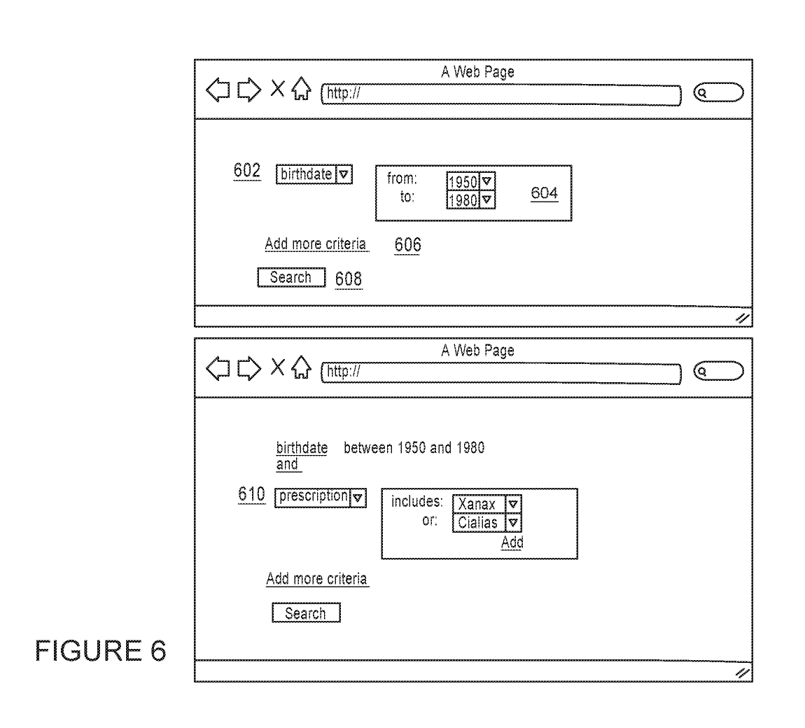

FIG. 6 is a schematic illustration of a user interface for defining parameters of a query on a client device, according to an embodiment (e.g., with reference the components described in FIG. 1). In some implementations, a user can use the server application 104 to specify criteria and/or parameters 602 to include within a search query. For example, the user can specify ages by selecting a “birthdate” criterion, and can then select a birth date range 604 over which the longitudinal data server 108 should search population records. The user can then add more criteria 606, and/or can press a search and/or similar submit button 608 to send her query parameters to the longitudinal data server 108 so that the query engine module 112 can construct a query based on birthdate information. Adding additional criteria and/or parameters 610 can allow a user to build more complex queries over larger amounts of data.

The query engine module 112 can bind expressions, e.g., using standard Boolean operators (AND, OR), group fields into clauses (e.g. “(X AND Y) OR (A AND B)”), and negate clauses (e.g. “(X OR Y) AND NOT (A OR B)”). In some implementations, the data the user can search can also be defined to be a random sample of a specified size, either across an entire population being requested by the user, or a subset of the population as defined by a preexisting saved query.

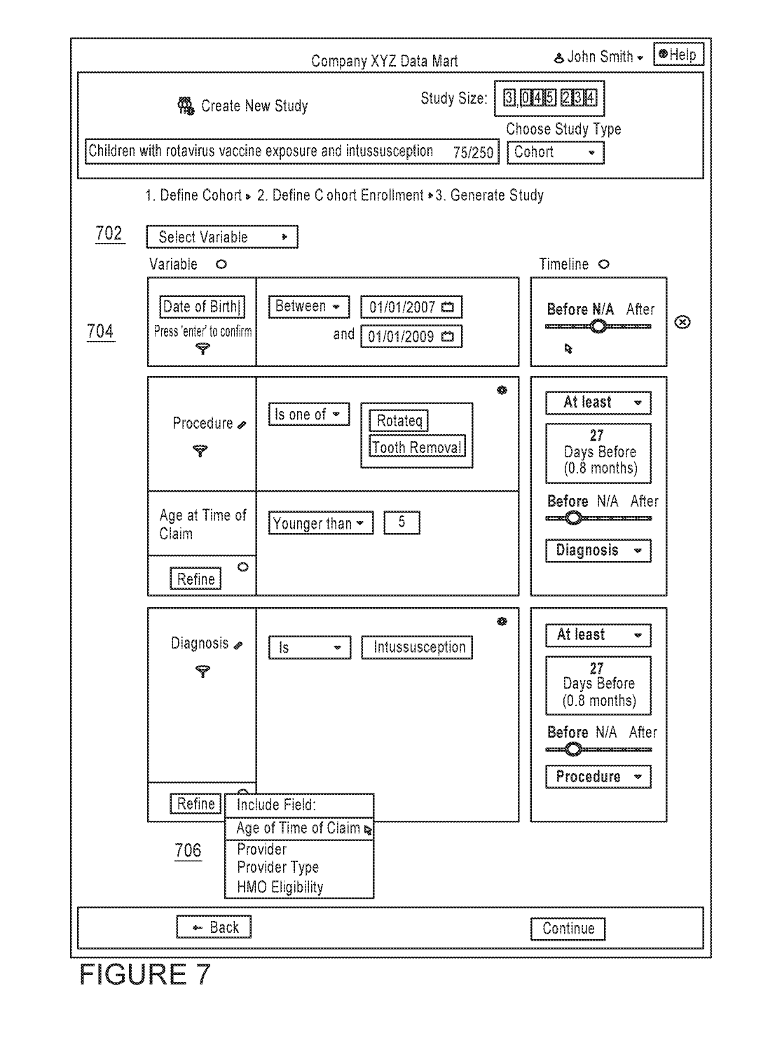

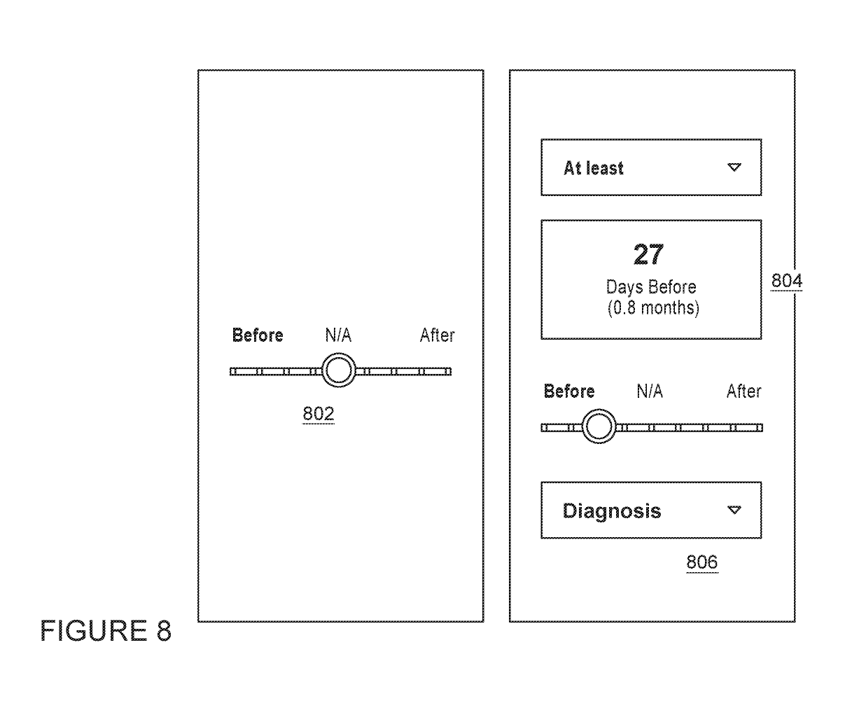

FIG. 7 is a schematic illustration of a user interface for adding parameters in a query on a client device, according to an embodiment (e.g., with reference the components described in FIG. 1). For example, in some implementations, users can select 702 variables and/or parameters to provide the query engine module 112 to construct a query. A user can specify a number of attributes 704 for each parameter, such as a keyword (e.g., corresponding to a table name, and/or the like), a date range and/or other time specification for the parameter, and/or indicators as to whether the parameter temporally follows or precedes other parameters. For example, referring to FIG. 8, the user can use a sliding scale mechanism 802, to determine whether a parameter should temporally follow or proceed other parameters 806 in the query. The user can also specify specific time periods 804 by which a parameter should precede or follow other parameters 806. For example, the user can specify that records retrieved using the final query should include records in which a patient has reached a certain age at least 27 days before a diagnosis, and/or the like.

Returning to FIG. 7, the user can also refine 706 the parameters, e.g., using field values and/or other such attributes, to further refine the scope of the query. In some implementations, such field values can be associated with names of fields and/or attributes for a record in the table specified by the parameter name. Diagnosis parameter fields can include, for example, the age of a patient at the time of the diagnosis, a provider who provided the diagnosis, the provider's type, and/or other such fields.

FIG. 9 is a schematic illustration of a user interface for adding events to a query, according to an embodiment (e.g., with reference the components described in FIG. 1). For example, a user can specify enrollment filters 902 to further refine the query that will be defined by the query engine module 112. For example, the user can manipulate user interface fields 904 to specify requirements for enrollment of individuals in a study, a study on a condition, and/or the like. For example, the user can specify a minimum age for a diagnosis, and can select requirements that require the date of birth of the people included in the study, in addition to an earliest date of a diagnosis, to be within a predetermined range. Users can also limit individual records included in the study based on whether those individual records would be disenrolled (e.g., removed from) from the study 906.

For example, statistics for a study with enrollment filtering requirements can be generated against an overall date range specified for the study (e.g., year 2000-year 2010). Thus can allow the user to limit which records in the longitudinal data database 110 can be included in further processing of the user's query. If the enrollment requirements are specified in terms of an aggregate value and/or collection of a parameter (e.g., an enrollment requirement that “individuals are continually enrolled between date of birth and the average first date of diagnosis” includes an aggregate value “average age of first diagnosis”), a pre-filtering step can be performed. The pre-filtering step can include removing individuals from the study if they are not enrolled between the pre-aggregated dates specified by the user. As an example, individuals who were not enrolled between their own date of birth and the age of their first date of diagnosis can be removed from the study. Enrollment filtering can then be performed by calculating any aggregated parameters specified (e.g., calculating the average age of first diagnosis), and removing the individuals who do not meet the conditions from the study. Statistics on the results can then be recalculated between the dates identified as the enrollment period, e.g., on an individual-by-individual basis.

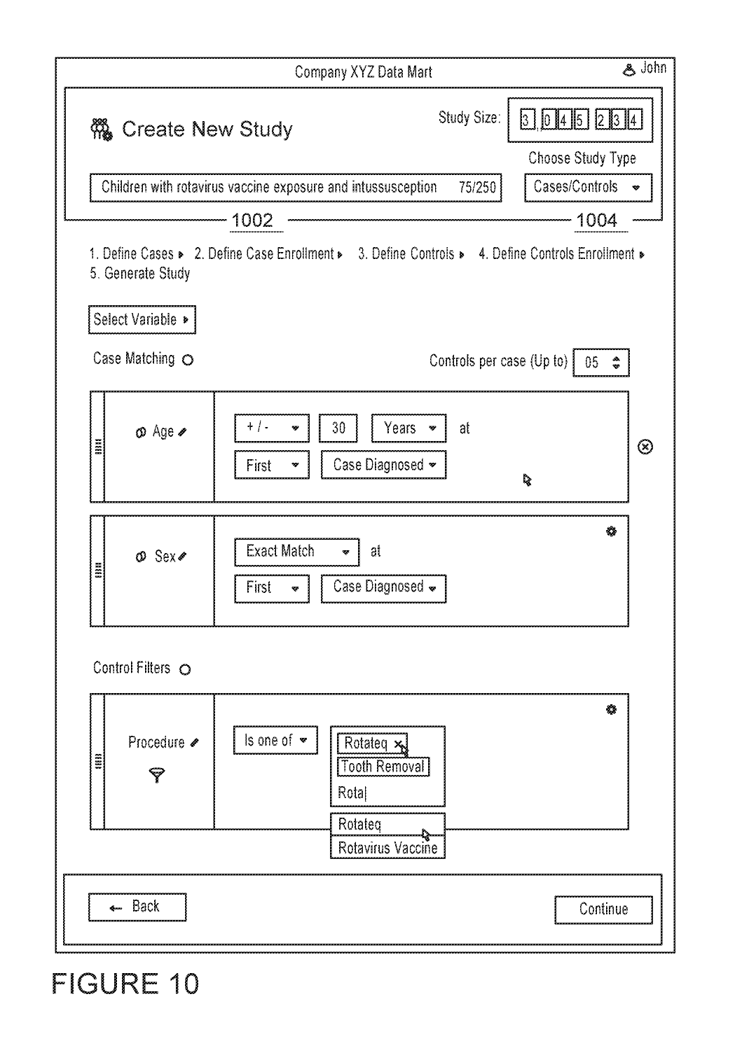

FIG. 10 is a schematic illustration of an example user interface for query definition, according to an embodiment (e.g., with reference the components described in FIG. 1). In some implementations, the user can define a new study on a condition, and/or other parameters. For example, the user can specify a set of query parameters 1002 to include in a query, in order to obtain a population of people with the condition, and a population for a control group without the condition, and/or the like. The user can specify a study type 1004, such as a cases/controls study (e.g., a study comparing people with a condition to people without the condition). The user can then also specify further parameters, and/or edit parameters provided in the query parameters 1002, using the user interface within the server application 104.

While shown and described above as being used to generate and/or use longitudinal queries on distributed data sources, in other embodiments the system can be used to automate and/or simplify any process that involves the processing of distributed data sources using complex queries. The system can further use temporally-related data to generate predictions based on large quantities of data, using the intelligent generation of multi-segment queries, and using data structures defined by execution of the queries. For example, such a system could be used for health data, transactional and/or other business and/or ecommerce data, log data from devices connected to a network server, and/or the like.

It is intended that the systems and methods described herein can be performed by software (stored in memory and/or executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including Unix utilities, C, C++, Java™, Ruby, SQL, SAS®, the R programming language/software environment, Visual Basic™, and other object-oriented, procedural, or other programming language and development tools. Examples of co er code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code. Each of the devices described herein can include one or more processors as described above.

Some embodiments described herein relate to devices with a non-transitory computer-readable medium (also can be referred to as a non-transitory processor-readable medium or memory) having instructions or computer code thereon for performing various computer-implemented operations. The computer-readable medium (or processor-readable medium) is non-transitory in the sense that it does not include transitory propagating signals per se (e a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices, Other embodiments described herein relate to a computer program product, which can include; for example, the instructions and/or computer code discussed herein.

While various embodiments have been described above, it should be understood that they have been presented by way of example only, and not limitation. Where methods and steps described above indicate certain events occurring in certain order, the ordering of certain steps may be modified. Additionally; certain of the steps may be performed concurrently in a parallel process when possible, as well as performed sequentially as described above. Although various embodiments have been described as having particular features and/or combinations of components, other embodiments are possible having any combination or sub-combination of any features and/or components from any of the embodiments described herein. Furthermore, although various embodiments are described as having a particular entity associated with a particular compute device, in other embodiments different entities can be associated with other and/or different compute devices.

What is claimed is:

1. A system, comprising:
a processor;
a longitudinal database operatively coupled to the processor; and
a memory operatively coupled to the processor, the memory storing processor-readable instructions executable by the processor to:
determine a temporal relationship among a plurality of search parameters for a longitudinal query; and
in response to the temporal relationship among the plurality of search parameters indicating an order of a plurality of events associated with the plurality of search parameters:
classify each search parameter from the plurality of search parameters with a discrete event from the plurality of events,
determine global search parameters for the longitudinal query based on each discrete event from the plurality of events,
define a single-segment query for each discrete event from the plurality of events, the single-segment query for each discrete event from the plurality of events including (1) a set of search parameters from the plurality of search parameters that is unique to that discrete event and (2) the global search parameters,
define a multi-segment query based on each single-segment query defined for each discrete event from the plurality of events,
query a plurality of database tables from the longitudinal database based on the multi-segment query to retrieve multi-segment query results, and
render the retrieved multi-segment query results in a user interface.

2. The apparatus of claim 1, wherein the order of the plurality of events specifies an order of the plurality of events over a user-specified period of time.

3. The apparatus of claim 1, wherein:
each single-segment query for each discrete event from the plurality of events is determined based on a path between a focus parameter of that discrete event and a target parameter of that discrete event,
the path being determined based on a longitudinal database table graph.

4. The apparatus of claim 1, wherein the memory is further configured to store processor-readable instructions executable by the processor to:
retrieve, from the longitudinal database, a longitudinal database table graph,
identify a longitudinal database table graph node associated with a focus parameter of a discrete event (1) from the plurality of events and (2) associated with a search parameter from the plurality of search parameters,
identify a longitudinal database table graph node associated with a target parameter of that discrete event, and
identify a path between the longitudinal database table graph node associated with the focus parameter and the longitudinal database table graph node associated with the target parameter, the single-segment query for that discrete event being defined based on the path.

5. The apparatus of claim 1, wherein each discrete event from the plurality of events is one of a diagnosis, a medication, a symptom, a doctor visit, a hospital stay, or a medical procedure.

6. The apparatus of claim 1, wherein:
each single-segment query for each discrete event from the plurality of events is further defined based on a longitudinal database table graph, and
the longitudinal database table graph is associated with a plurality of longitudinal database tables stored at the longitudinal database.

7. The apparatus of claim 1, wherein:
the longitudinal database is a first longitudinal database,
each single-segment query for each discrete event from the plurality of events is further defined based on a longitudinal database table graph, and
the longitudinal database table graph is associated with a plurality of longitudinal database tables, at least one longitudinal database table from the plurality of longitudinal database tables being stored at a second longitudinal database different from the first longitudinal database.

8. A method, comprising:
identifying a plurality of temporal relationships between each query search parameter from a set of longitudinal query search parameters and the remaining query search parameters from the longitudinal query search parameters;
identifying (1) a focus parameter from the set of longitudinal query search parameters and (2) a set of target parameters from the set of longitudinal query search parameters;
calculating a set of longitudinal database table paths, each longitudinal database table path from the set of longitudinal database table paths being a path from a longitudinal database table node associated with the focus parameter to a different longitudinal database table node from a set of longitudinal database table nodes associated with the set of target parameters;
generating a set of longitudinal query segments based on each longitudinal database table path from the set of longitudinal database table paths;
combining the set of longitudinal query segments to generate a multi-segment ti-segment longitudinal query;
querying a plurality of longitudinal database tables based on the multi-segment longitudinal query, and
rendering multi-segment longitudinal query results in a user interface.

9. The method of claim 8, wherein at least one of the focus parameter or the set of target parameters is identified based on the plurality of temporal relationships.

10. The method of claim 8, wherein each longitudinal database table included in the longitudinal database table graph is stored at the database.

11. The method of claim 8, wherein at least one longitudinal database table included in the longitudinal database table graph is stored at a longitudinal database different from the database.

12. The method of claim 8, wherein each longitudinal database table path from the set of longitudinal database table paths is a shortest path from the longitudinal database table graph node associated with the focus parameter to a different longitudinal database table node from the set of longitudinal database table nodes.

13. The method of claim 8, wherein:
each longitudinal database table path from the set of longitudinal database table paths is associated with one of a filtering parameter or an unfiltering parameter,
each longitudinal query segment from the set of longitudinal query segments is combined into the multi-segment longitudinal query based on whether the longitudinal database table path associated with that longitudinal query segment includes the filtering parameter or the unfiltering parameter.

14. The method of claim 8, wherein:
the longitudinal database table graph is generated based on metadata specifying a longitudinal database table topology,
the metadata representing a relatedness of data in each longitudinal database table represented in the longitudinal database table graph to other longitudinal database tables represented in the longitudinal database table graph.

15. The method of claim 8, further comprising:
retrieving, from a database, a longitudinal database table graph, the longitudinal database table graph including (1) the longitudinal database table node associated with the focus parameter and (2) the set of longitudinal database table nodes associated with the set of target parameters.

16. A processor-readable non-transitory medium storing code representing instructions to be executed by a processor, the code comprising code to cause the processor to:
determine a first subset of search parameters from a set of search parameters, the first subset search parameters being related to a condition;
determine a second subset of search parameters from the set of search parameters, the second subset of search parameters being related to one of the condition or a control group of individuals;
determine a third subset of search parameters from the set of search parameters, the third subset of search parameters including search parameters common to the first subset of search parameters and the second subset of search parameters;
generate a first longitudinal query based on (1) the first subset of search parameters, and (2) the third subset of search parameters;
generate a second longitudinal query based on (1) the second subset of search parameters, and (2) the third subset of search parameters;
retrieve first longitudinal query results from a plurality of longitudinal database tables, based on the first longitudinal query;
store the first longitudinal query results in a condition longitudinal database table;
retrieve second longitudinal query results from the plurality of longitudinal database tables, based on the second longitudinal query;
store the second longitudinal query results in a potential control group longitudinal database table; and
compare statistical data generated based on data in the condition longitudinal database table with statistical data generated based on data in the potential control group longitudinal database table to predict information relating to the condition.

17. The processor-readable non-transitory medium of claim 16, wherein the first subset of search parameters and the second subset of search parameters are determined based on (1) metadata or (2) previous parameter classifications.

18. The processor-readable non-transitory medium of claim 16, wherein the information relating to the condition is an influence of a predetermined parameter on the condition.

19. The processor-readable non-transitory medium of claim 16, wherein the information relating to the condition is a likelihood that individuals in the potential control group longitudinal database table will develop the condition.

20. The processor-readable non-transitory medium of claim 16, further comprising code representing instructions to cause the processor to:
filter each of the condition longitudinal database table and the potential control group longitudinal database table to remove excess data, and
perform statistical analysis of the data of the filtered conditional longitudinal database table and the filtered potential control group longitudinal database table.

21. The processor-readable non-transitory medium of claim 16, further comprising code representing instructions to cause the processor to:
filter data stored in the potential control group longitudinal database table based on filtering parameters included with the set of search parameters; and
modify an amount of data stored in the condition longitudinal database table based on a comparison of the amount of data stored in the condition longitudinal database table and an amount of data stored in the potential control group longitudinal database table.
